(19) United States
(12) Patent Application Publication
(10) Pub. No.: US 2017/0023164 A1
(43) Pub. Date: Jan. 26, 2017

(54) PIPE CONNECTOR AND METHOD FOR MANUFACTURING A PIPE CONNECTOR

(71) Applicant: EICHENAUER HEIZELEMENTE GMBH & CO. KG, Kandel (DE)

(72) Inventors: Christian WILDEGGER, Waldfischbach (DE); Ulrich SCHLACHTER, Herxheim-Hayna (DE)

(21) Appl. No.: 15/215,283

(22) Filed: Jul. 20, 2016

(30) Foreign Application Priority Data
Jul. 24, 2015 (DE) 102015112137.9

(51) Int. Cl. F16L 53/00; H01R 24/20

(52) U.S. Cl. CPC F16L 53/008; H01R 24/20

(57) ABSTRACT

The invention relates to a pipe connector with a first media connection for connecting a pipe for a medium to be heated, with a heating element, which is disposed on a pipe element capable of being passed by the medium, and with at least one further media connection. Herein, the pipe element and the heating element disposed on the pipe element are surrounded by a sleeve element. The sleeve element is disposed in a housing of the pipe connector, by which the media connections are formed. Furthermore, the invention relates to a method for manufacturing such a pipe connector.

The invention relates to an electrically heatable pipe connector with a first media connection for connecting a pipe for a medium to be heated and with at least one further media connection. In addition, the pipe connector has a pipe element capable of being passed by the medium. Moreover, the invention relates to a method for manufacturing such a pipe connector.

Such heatable pipe connectors are for example employed to defreeze or heat a medium like a urea solution or to prevent freezing of the urea solution. Usually, the urea solution is employed in a motor vehicle to release ammonia from the urea in an exhaust gas tract of the motor vehicle. The ammonia is in turn introduced into a so-called SCR catalyst (SCR=selective catalytic reduction) to there effect reduction of nitrogen oxides from the exhaust gas in a selective catalytic reduction reaction.

Commercial aqueous urea solutions freeze at about −11 degrees Celsius. Correspondingly, it is required at low ambient temperatures to defreeze the urea solution in order that the urea is available for exhaust gas after-treatment. However, electrically heatable pipe connectors of the initially mentioned kind can for example also be employed for washing liquid pipes of a windscreen washer system of a motor vehicle. Moreover, other fields of employment are conceivable, in which heating of an in particular liquid medium is concerned.

EP 2 137 449 B1 describes a pipe connector with a connector piece formed as a plastic molding, which has two connecting sections. A media pipe and an aggregate can be connected to the pipe connector via the connecting sections. In a transitional section of the connector piece formed between the connecting sections, a flow channel is formed. Herein, an electrical heating wire is wound around the transitional section or laid along the transitional section in other, for example meandering manner. The connector piece is disposed within an exterior housing, which can be constructed in two-part manner or be formed as an overmold of the connector piece.

A further such pipe connector is described in EP 1 985 908 B1 and in EP 2 220 419 B1. In EP 2 220 419 B1, the heating wire of the pipe connector is additionally electrically conductively connected to a heating wire of a fluid pipe, wherein junctions of the heating wires are embedded in a plastic molding compound and thus immovably fixed. The connection of these loose wires to each other is herein effected manually, which entails high manufacture effort. Such pipe connectors are therefore expensive in production.

Therefore, it is the object of the present invention to provide a functionally safe pipe connector particularly simply to handle in terms of manufacture as well as a method for manufacturing such a pipe connector.

This object is solved by a pipe connector and a method for manufacturing a pipe connector according to the independent claims.

According to a first aspect of the invention, the pipe connector has a first media connection, to which a pipe for a medium to be heated can be connected. Furthermore, a heating element is provided, which is disposed on a pipe element of the pipe connector, wherein the pipe element is capable of being passed by the medium. The pipe connector has at least one further media connection. Herein, the pipe element and the heating element disposed on the pipe element are surrounded by a sleeve element. The sleeve element is disposed in a housing of the pipe connector, wherein the media connections are formed by the housing.

This is based on the realization that in disposing the housing of the pipe connector at the pipe element, it is to be ensured as largely as possible that the heating element disposed on the pipe element does not displace or is even damaged. Presently, this is ensured in that the pipe element, on which the heating element is disposed, is surrounded or encompassed by the sleeve element, thus disposed within the sleeve element. Thus, protection of the heating element from undesired mechanical loads is achieved by the sleeve element. In this manner, it can in particular be ensured that the heating element remains disposed on the pipe element in the provided manner and is not impaired by attaching or disposing the housing, which surrounds the sleeve element. Thereby, a particularly great functional safety of the pipe connector is ensured, which additionally is particularly simply to handle in terms of manufacture.

Furthermore, the pipe element, which is heatable by means of the heating element and capable of being passed by the medium, can presently be particularly simply constructed, for example in the manner of a tubular member produced separately or independently of the housing, in particular in the manner of a cylindrical pipe piece. Because, presently, the media connections are not provided by this pipe element, but only by the housing, in which the sleeve element is disposed, wherein the sleeve element in turn protects the pipe element. Thus, a similar pipe element, thus formed as a standard part, with the heating element disposed thereon can be employed for different pipe connectors in particular independently of the configuration and spatial orientation of the media connections.

Therein, the pipe element is preferably first provided as a member separate from the housing. The heating element can then be disposed on this separate member in a desired manner, which is subsequently surrounded by the sleeve element. In other words, the pipe element is first formed as an independent member separate from the housing. This separate pipe element is only disposed in the housing in manufacture of the pipe connector and for example fixed in the housing by overmolding the sleeve element with plastic material forming the housing. The sleeve element is preferably also a member separate from the pipe element. The pipe connector is thus preferably constructed in multi-part manner as a whole and in particular includes the pipe element and the sleeve element as independent, prefabricated provided members or components. However, for instance in producing the housing by injection molding, the sleeve element and/or the pipe element can be connected to the material forming the housing in firmly bonded manner in the finished pipe connector. Furthermore, the pipe element and the sleeve element can also be integrally formed.

Accordingly, in a preferred configuration of the pipe connector, the housing is formed as an injection molding part, which is formed by overmolding the sleeve element surrounding the pipe element with a plastic. Namely, the molten plastic is introduced into the injection molding tool under very high pressure in injection molding. Thus, protection of the heating element from contact with the plastic melt forming the housing is here particularly reasonable to avoid a change of the position of the heating element or damage of the heating element. Furthermore, particularly good connection of the sleeve element to the housing can thus be achieved such that a particularly compact and robust pipe connector is realizable. In addition, the formation of the housing as an injection molding part offers a particularly great freedom in the configuration of the media connections as well as the spatial orientations of the media connections.

Herein, it has appeared advantageous if the pipe element and the sleeve element are collectively and completely overmolded with plastic in injection molding the housing. A channel for the medium, which is formed by the pipe element capable of being passed by the medium is then also internally lined with the injection molding material. Thereby, it is ensured that the medium only comes into contact with the overmold provided by the housing in the operation. In particular, also a comparatively aggressive medium like urea thus cannot come into contact with the heating element.

Furthermore, it is conducive to the simple construction of the pipe connector if the heating element is disposed on an outer side of the pipe element. Hereto, the heating element can in particular be formed as a heating wire circulating around the pipe element in coil-shaped manner. Because, in this manner, a particularly uniform heating of the medium passing through the pipe element can be achieved since thermal heat can be input into the medium over the entire circumference of the pipe element. However, if the occurrence of coil effects is to be avoided in the heating element, the heating wire can for example be laid on the outer side of the pipe element in meandering loops. Herein, the parallel sections of the loops can substantially extend in the axial direction of the pipe element. However, in this manner of the arrangement of the heating wire or heating element on the pipe element too, good heat input into the medium can be achieved.

It has further appeared advantageous if an air gap is formed at least in certain areas between the heating element and the sleeve element. Namely, such an air gap ensures thermal insulation such that the heat delivered by the heating element is particularly largely input into the medium, which passes through the pipe element. Thus, heat is lost to the environment to reduced extent since particularly little heat is transmitted to the sleeve element or to the housing. The air gap can in particular be formed circumferentially circulating around the pipe element and/or extend at least over a length in axial direction, over which the heating element is disposed on the pipe element. Preferably, a contact between the sleeve element and the heating element is correspondingly avoided by the air gap. By providing the air gap, a particularly efficient heating of the medium can be achieved.

The sleeve element can be slid onto the pipe element provided with the heating element. Additionally or alternatively, clamping or locking the sleeve element with the pipe element having the heating element is for example possible to achieve a secure and strong retention of the pipe element within the sleeve element. However, other or further types of fixing the sleeve element to the pipe element provided with the heating element can also be provided.

Namely, the sleeve element can be formed in the manner of a shrinking hose, which contracts around the pipe element after inserting the pipe element which is provided with the heating element into the sleeve element. Herein, by providing spacers, it can be ensured that the air gap is still formed between the heating element and the sleeve element.

Furthermore, the sleeve element can be formed in multi-part, in particular two-part, manner, wherein the parts can be assembled after arranging the pipe element on at least one of the parts and thus the sleeve element can be formed. For example, the sleeve element can be formed of two half-shells, which enclose the pipe element provided with the heating element when the two half-shells are assembled.

In order to ensure a defined position of the pipe element within the sleeve element, the sleeve element can have at least one stop, on which an axial end of the pipe element abuts. This is in particular favorable if the sleeve element is slid onto the pipe element.

It has appeared further advantageous if the sleeve element has at least one radially protruding structural element. Such structural elements for example formed as ribs or webs contribute to a particularly good adherence of the housing material to the sleeve element if the housing is formed as an injection molding part, thus if the sleeve element is overmolded with plastic in the manufacture of the pipe connector.

It is further advantageous if at least one pipe section for the medium is formed by the housing of the pipe connector, which fluidically connects an end of the pipe element to one of the media connections formed by the housing. Thus, the pipe element preferably has a first, in particular axial end or a first end side, which is spaced from the first media connection, and a second, in particular axial end or a second end side, which is spaced from the further media connection. In other words, thus, pipes or connecting pieces of an aggregate such as a pump or the like connected to the respective media connection do not get into contact with the pipe element, but only with the housing of the pipe connector. Thus, since the pipe element preferably formed as a member separate from the housing does not have to be formed for connecting the pipe for the medium to be heated or a connecting piece of an aggregate or the like, a very simply formed pipe element can be used for the pipe connector. This too is conducive to the simple construction of the pipe connector.

Preferably, the heating element is connected to at least two electrical connecting parts, via which the heating element can be supplied with electrical current. Namely, plug connectors for connecting a voltage source and/or a heatable pipe for the medium to be heated can thus be provided by the pipe connector. In particular, the connecting parts can be formed as intrinsically stiff sheets. This is advantageous on the one hand if the heating element is to be electrically connected by means of a plug connector. Furthermore, such connecting parts exactly positioned in the pipe connector due to their stiffness allow electrical connection to wires of a plug connector or a media pipe by a welding method, in particular by spot welding. Thus, automated manufacture is allowed, in which manual work in electrically connecting can be particularly largely and in particular completely omitted. This too facilitates the incorporation of the pipe connector in an electrically heatable pipe system. Furthermore, the pipe connector thus is particularly simply to handle in terms of manufacture.

It has appeared further advantageous if the pipe connector has two first electrical connecting parts, which are connected to the heating element, and two further electrical connecting parts, which are galvanically separated from the first electrical connecting parts and connected to each other. In this configuration, an extended functionality is provided by the pipe connector. Namely, optionally by connecting a voltage source only to the two first electrical connecting parts, exclusively the pipe connector can be supplied with electrical energy. In this case, the two further connecting parts galvanically separated from the first electrical connecting parts (and thus also from the heating element) then remain unused.

However, by providing the two further electrical connecting parts, a series connection of the electrically heatable heating element of the pipe connector with a further electrically heatable component of a pipe system including the pipe connector can be achieved in very simple manner. Herein, expensive wiring of the pipe connector is not required, for instance by manually connecting electrical wires to the respective connecting parts and embedding them in a plastic compound as in methods known from the prior art. Rather, the connecting parts can be automated connected to the further electrically heatable component of the pipe system in firmly bonded manner—in particular before optional embedding of the connecting parts in a plastic compound—for instance by a welding method, in particular by spot welding. Herein, an automatic welding machine, but also an industrial robot can for example be employed.

Rather, the respectively desired components can be connected by providing the first electrical connecting parts and the further electrical connecting parts in one and the same pipe connector in particularly inexpensive manner. This can in particular be effected by use of a simple plug connection and/or by firmly bonded connection of the electrical connecting parts to respectively associated connecting parts of the further electrically heatable component of the pipe system or a plug connector connected to a voltage source.

Namely, the formation of such plug connections and/or of firmly bonded connections such as welding connections, in particular laser welding connections, and/or soldering connections can in particular be achieved particularly simply in automated manner and thus particularly inexpensively. Namely, both the electrical contact by plug connectors and the firmly bonded connection for instance by lasing or soldering can be performed in automated manner safe in process and with low effort, wherein in particular spot welding can be employed. However, a mechanical connection for example in the manner of a flat plug-in sleeve is also conceivable.

Herein, it has appeared advantageous if a first connection device is provided by one of the first electrical connecting parts and one of the further electrical connecting parts, which serves for connecting the pipe connector to a voltage source. Herein, a further connecting device for connecting an electrically heatable component is provided by the other one of the first electrical connecting parts and the other one of the further electrical connecting parts. Thus, the voltage supply for the pipe connector itself as well as of the electrically heatable component connected to the pipe connector can be ensured via one and the same pipe connector. Hereto, the voltage source only has to be connected to the first connecting device and the further component to the further connecting device. This makes the pipe connector particularly flexibly employable.

Namely, in this manner, a series connection of the heating element of the pipe connector and the further electrically heatable component can in particular be achieved. Such a series connection has the advantage that a defect or a malfunction with regard to the electrical connection of an individual one of the components can be particularly easily determined. Namely, if the first connecting device or a plug connector connected to it is for example defective and thus the heating element can for example not be supplied with electrical energy, thus, the further electrically heatable component is also affected. This makes it particularly simple to detect the corresponding failure or a malfunction. In contrast, if the respective pipe connector and each electrically heatable component of a pipe system including the pipe connector are individually connected to respective voltage sources or to the same voltage source, thus, this firstly entails increased effort. And secondly, each of the electrical connections would then have to be individually monitored to be able to detect a malfunction of the respective component of the electrically heatable pipe system.

By providing the first connecting device and the further connecting device of the pipe connector, it can thus be integrated in the electrically heatable pipe system in particularly flexible and simple manner, and a malfunction in electrically heating can additionally be particularly easily determined.

In particular, at least one heating wire of the pipe for the medium to be heated can be firmly bonded or mechanically connected to the further connecting device. In other words, thus, the pipe for the medium to be heated can be connected in series with the pipe connector in simple and low-effort manner by coupling the heating wires to the further connecting device, which has the at least two connecting devices. Herein, the firmly bonded connection can be made in automated manner, for instance by connecting the heating wires to the intrinsically stiff connecting parts of the further connecting device by spot welding. Subsequently, the junctions of the heating wires to the connecting parts can be embedded in a plastic compound, for instance by applying hot glue to the junctions, by casting with a plastic compound or the like.

Heating wires of the pipe for the medium to be heated can alternatively also be electrically conductively coupled to the further connecting device via a plug connector.

The pipe for the medium to be heated can in turn be electrically conductively connected to the heating element of a further pipe connector. Thus, the further pipe connector can also be electrically connected in series with the pipe connector having the two connecting devices. In this manner, by connecting the voltage source only to the first connecting device of the pipe connector, the heating of the entire pipe system can be ensured in simple and low-effort manner. Thus, in particular by means of a single plug connector providing a supply voltage, a pipe connector both close to the plug connector and spatially far from the plug connector can be supplied with electrical energy.

However, it is alternatively also conceivable that only one pipe connector is electrically connected in series with the electrically heatable pipe without a further pipe connector being electrically connected to this pipe.

It is furthermore preferred if end areas of the electrical connecting parts are disposed within at least one socket, which is formed by the housing of the pipe connector. Thus, by plugging a plug into the socket, a voltage supply of the heating element can be ensured and/or an electrically heatable pipe can be connected to the pipe connector. However, additionally or alternatively to the socket, a plug connector can also be formed by the housing, which in turn can be inserted into a socket of a pipe for the voltage supply or a media pipe.

Furthermore, only wires can also be connected to the connecting parts preferably formed as intrinsically stiff sheets, for instance by spot welding, which lead to a plug connector or a socket. Into such a socket (spaced from the pipe connector), a supply plug of a voltage source can then for example be plugged to ensure the voltage supply in the operation of the pipe connector.

Contacting of the heating element can be realized by injecting electrical connecting parts. Thus, electrical connecting parts can be fixed to the pipe element by overmolding with a plastic material. Herein, the plastic material preferably forms the pipe element. In other words, the pipe element can be formed as a for example cylindrical plastic tube piece. The heating element can for instance be disposed in the form of the heating wire on this tube piece, for example by wrapping the tube piece with the heating wire. The two ends of the heating wire are each fixed at an end of the injected connecting parts, preferably in firmly bonded manner, e.g. by spot welding, however, a mechanical connection is also conceivable. In this manner, a particularly secure spatial fixing of the electrical connecting parts for further contacting can be achieved.

It is further advantageous if at least one of the media connections is formed for connecting the pipe connector to a pumping device serving for conveying the medium to be heated. Thus, it can be ensured that the medium conveyed by the pumping device can be supplied with the thermal heat provided by the pipe connector immediately in exiting from the pumping device. In this manner, it can be ensured that the medium is available for the desired purpose of employment.

With regard to the installation space demanded by the pipe connector, it can be advantageous if central axes of the media connections include an angle, in particular an angle of about 90 degrees.

According to a further aspect of the invention, a method according to the invention for manufacturing a pipe connector includes the steps of:

a) providing a pipe element capable of being passed by a medium;

b) disposing a heating element on the pipe element;

c) surrounding the pipe element and the heating element disposed on the pipe element with a sleeve element; and

d) disposing the sleeve element in a housing of the pipe connector, wherein a first media connection for connecting a pipe for the medium to be heated and at least one further media connection are formed by the housing.

Thus, the pipe element is first provided as a separate member. After disposing the heating element on the pipe element, the sleeve element is provided as a further separate member. The sleeve element, which surrounds the pipe element and the heating element disposed on the pipe element, is then disposed in the housing of the pipe connector, by which the media connections are formed. By means of this method, a simply constructed and functionally safe pipe connector can be provided.

The advantages and preferred embodiments described for the pipe connector according to the invention also apply to the method according to the invention and vice versa.

The features and feature combinations mentioned above in the description as well as the features and feature combinations mentioned below in the description of figures and/or shown in the figures alone are usable not only in the respectively specified combination, but also in other combinations or alone without departing from the scope of the invention. Thus, implementations are also to be considered as encompassed and disclosed by the invention, which are not explicitly shown in the figures or explained, but arise from and can be generated by separated feature combinations from the explained implementations.

Further advantages, features and details of the invention are apparent from the claims, the following description of preferred embodiments as well as based on the drawings, in which functionally identical elements are provided with identical reference characters. There show:

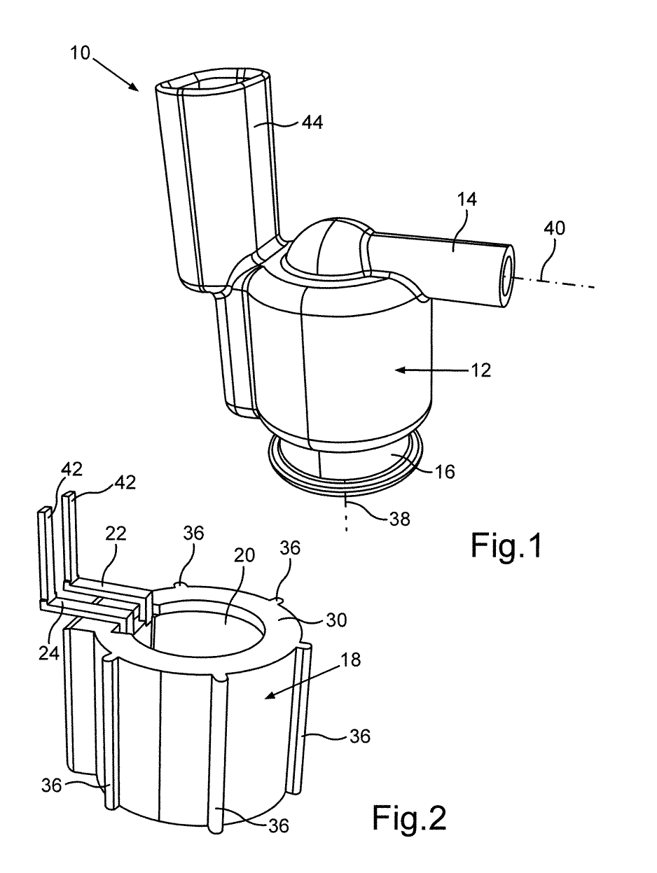

FIG. 1 in a perspective view an electrically heatable pipe connector, which has media connections for connecting a pipe for a medium to be heated and for connecting to a pump, wherein a housing of the pipe connector forms a socket for electrically connecting a heating element of the pipe connector;

FIG. 2 a perspective view of components of the pipe connector according to FIG. 1, which are surrounded by the housing formed as an injection molding part, wherein these components include a sleeve and a pipe element disposed in the sleeve;

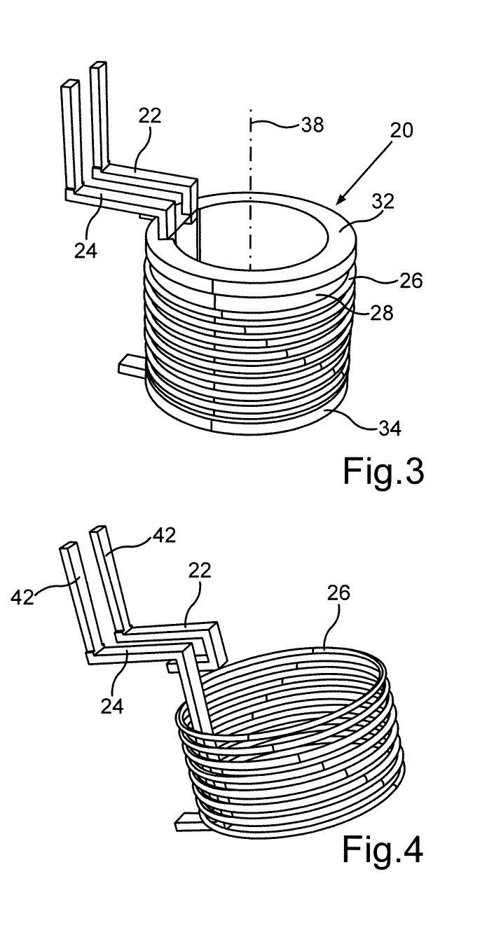

FIG. 3 in perspective manner the pipe element according to FIG. 2 with a heating wire circulating around an outer side of the pipe element;

FIG. 4 the heating wire according to FIG. 3 as well as two electrical connecting parts, which are connected to respective ends of the heating wire;

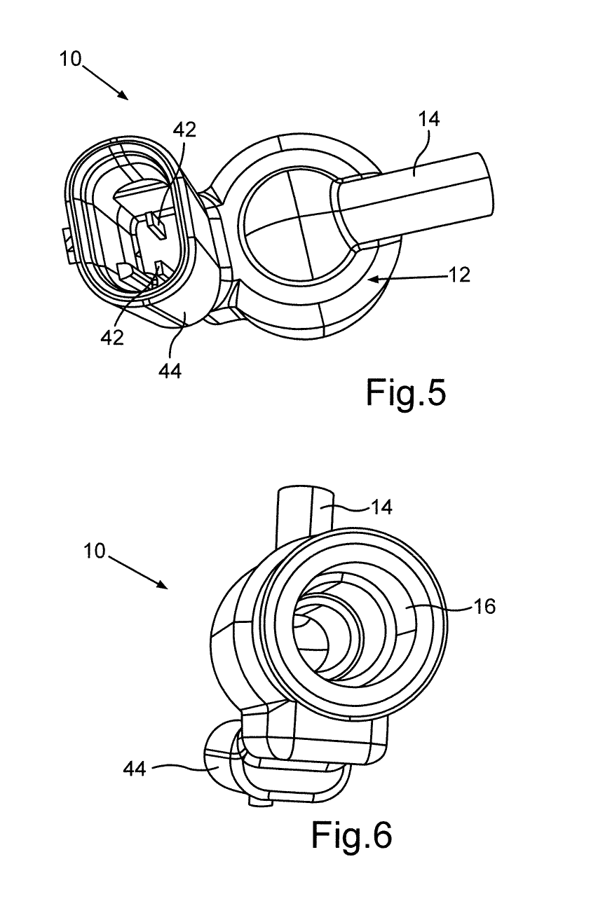

FIG. 5 a further perspective view of the pipe connector according to FIG. 1, from which the arrangement of end areas of the electrical connecting parts within the socket is apparent;

FIG. 6 the pipe connector according to FIG. 1 in a further perspective view of one of the media connections; and

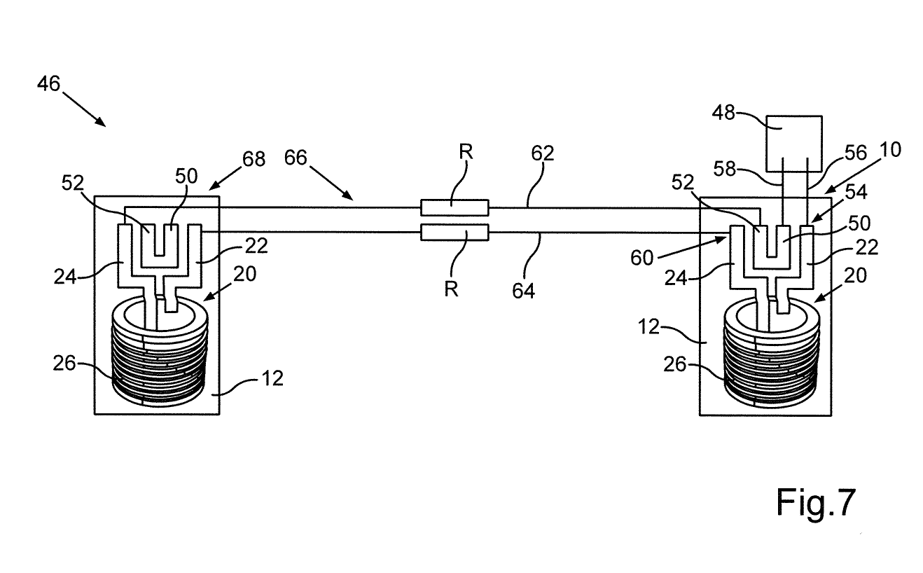

FIG. 7 schematically an arrangement of a variant of the pipe connector in an electrically heatable pipe system including two such pipe connectors, wherein one of the pipe connectors is connected both to a voltage source and to an electrically heatable media pipe, and wherein the second pipe connector is electrically connected to the media pipe.

An electrically heatable pipe connector 10 shown in FIG. 1 serves for heating a medium, which can pass through the pipe connector 10. This medium can for example be an aqueous urea solution as it is employed in the exhaust gas after-treatment in particular in motor vehicles. Furthermore, a washing liquid for a windscreen washer system of a vehicle can be heated by means of the heatable pipe connector 10. However, other fields of employment are also conceivable, in which a medium is to be supplied with thermal heat.

The pipe connector 10 includes a housing 12 formed as an injection molding part. Presently, a first media connection 14 is formed by the housing 12, via which a pipe 66 for the medium to be heated (compare FIG. 7) can be connected to the pipe connector 10. For example, the pipe 66 can be slid onto the first media connection 14. However, the first media connection 14 can also be formed for introducing the pipe 66 into the media connection 14 in alternative configurations of the pipe connector 10.

A further media connection 16 formed by the housing 12 is presently formed to couple the pipe connector 10 to a connecting piece of a pump, which conveys the medium to be heated. For example, this presently wider media connection 16 can be slid onto the connecting piece of the pump. However, other types of the connection, for example locking connections or plug connections, of the respective media connections 14, 16 to aggregates or media pipes carrying the medium are also possible.

In the interior of the housing 12, namely between the first media connection 14 and the further media connection 16, a sleeve 18 is provided in the variant of the pipe connector 10, the components of which disposed within the housing 12 are shown in FIG. 2. This sleeve 18 surrounds a pipe element 20 formed of a plastic, which is shown without the sleeve 18 in FIG. 3. Correspondingly, it is apparent that the pipe element 20 is a tubular member separate from the further components of the pipe connector 10, in particular from the sleeve 18 and from the housing 12, which is provided as an independent component independently of the housing 12 in the manufacture of the pipe connector 10.

Furthermore, it is well apparent from FIG. 3 that two metallic connecting parts 22, 24 are injected into the plastic material of the pipe element 20, thus fixed to the pipe element 20 by overmolding. The two connecting parts 22, 24 presently formed as intrinsically stiff sheets serve for supplying an electrical heating element, which is formed as a heating wire 26 in this variant of the pipe connector 10, with electrical energy for heating the medium, which passes through the pipe element 20. Presently, the heating wire 26 is wound around the pipe element 20 formed as a cylindrical receptacle. The heating wire 26 circulating around the pipe element 20 in coil-shaped manner thus abuts on an outer side 28 of the pipe element 20. The contact of the heating wire 26 with the connecting parts 22, 24 is preferably effected by spot welding. However, other firmly bonded or mechanical connections are also conceivable.

In particular if the heating wire 26 is wound around the pipe element 20 with comparatively low distance of the individual turns from each other, the heating wire 26 can be provided with an electrically insulating envelope. Then, an electrically conducting connection between the turns does not occur even upon contact of the turns of the heating wire 26 with each other.

By the sleeve 18 (compare FIG. 2), in overmolding the pipe element 20 and the heating wire 26 disposed on the pipe element 20, it is ensured that the heating wire 26 does not shift or is otherwise damaged in injection molding the housing 12. Namely, the plastic material (which forms the housing 12 after curing) is introduced under high pressure into the injection molding tool, in which the housing 12 is molded by overmolding the sleeve 18. However, since the sleeve 18 shields the heating wire 26 and protects it from contact with the plastic melt, the provided arrangement of the heating wire 26 on the pipe element 20 is maintained. Advantageously, the sleeve 18 also surrounds the contact points of the heating wire 26 with the connecting parts 22, 24 such that they are also protected.

The sleeve 18 can be slid onto the pipe element 20 with the heating wire 26 disposed thereon. Alternatively, the sleeve 18 or such a sleeve element can be formed in the manner of a shrinking hose, which contracts after disposing the pipe element 20 within it by heat effect. It is also possible to form the sleeve 18 in multi-part, in particular in two-part, manner and to assemble the parts such that they enclose the pipe element 20 with the heating wire 26 disposed thereon.

Presently, a stop is provided by an edge web 30 of the sleeve 18, on which the pipe element 20 abuts with an axial end or an end side 32. As is apparent from FIG. 3, this end side 32 of the pipe element 20 is presently provided by an annular flange, the area of which protrudes beyond the outer side 28 of the pipe element 20, on which the heating wire 26 abuts. In analogous manner, a further annular flange 34 protruding beyond the outer side 28 of the pipe element 20 is provided at an opposing axial end of the pipe element 20. In this manner, it can presently be ensured that a thermally insulating air gap is present between the heating wire 26 and the sleeve 18.

Furthermore, it is apparent from FIG. 2 that the sleeve 18 can have ribs 36 or similar radially protruding structural elements. They in particular ensure good anchorage of the sleeve 18 within the final overmold, thus in the housing 12 formed as the injection molding part.

In particular, it is apparent from FIG. 4 that the first electrical connecting part 22, which is connected to a first end of the heating wire 26 (in a manner not illustrated in more detail in FIG. 4), is shorter in axial direction of the pipe element 20 than the second electrical connecting part 24, which is connected to the second end of the heating wire 26. The axial extension of the pipe element 20, which is formed in the manner of a short tube piece, is illustrated in FIG. 3 by a central axis 38. This central axis 38 presently also corresponds to the central axis 38 of the further media connection 16.

As is apparent from FIG. 1, the central axis 38 of the further media connection 16 can include an angle, for example an angle of about 90 degrees, with a central axis 40 of the first media connection 14.

It is well apparent from FIG. 5 that end areas 42 of the electrical connecting parts 22, 24 can be disposed within a socket 44, which presently is also formed by the material of the housing 12. By introducing a plug connector into this socket 44, the heating wire 26 can be supplied with electrical current.

From the perspective view of the pipe connector 10 according to FIG. 6, the configuration of the further media connection 16 can be particularly well recognized, into which the connecting piece of the pump can be introduced.

In an electrically heatable pipe system 46 schematically shown in FIG. 7, a variant of the pipe connector 10 according to FIG. 1 is shown. Herein, the media connections 14, 16 are not illustrated in detail, but only possibilities of electrically connecting the pipe connector 10. Thus, the possibility is given by the two electrical connecting parts 22, 24 to couple the pipe connector 10 to a plug connector 48 of an electrical voltage source (not illustrated in more detail) and thus to ensure the voltage supply for the pipe connector 10.

However, the pipe connector 10 can also be electrically conductively connected to further components of the electrically heatable pipe system 46. Hereto, the pipe connector 10 has two further electrical connecting parts 50, 52. These two further electrical connecting parts 50, 52 are galvanically separated from the first electrical connecting parts 22, 24 and thus also from the heating element formed as the heating wire 26. However, the further electrical connecting parts 50, 52 are connected to each other such that they form a type of (presently U-shaped formed) bridge, the end areas of which can for instance be disposed in the socket 44.

Presently, by one of the first electrical connecting parts 22 and one of the further electrical connecting parts 50, a first connecting device 54 is provided, via which the pipe connector 10 can be connected to the voltage source. Hereto, the plug connector 48 only has to be coupled to this first connecting device 54. For example, this can be effected by corresponding introduction of the plug connector 48 into the socket 44 of the pipe connector 10. Additionally or alternatively, contact lines 56, 58 of the plug connector 48 can be connected to the two electrical connecting parts 22, 50 of the first connecting device 54 in firmly bonded manner, for instance by welding or soldering.

By the other one of the first electrical connecting parts 24 and the other one of the further connecting parts 52, a further connecting device 60 is provided. Heating wires 62, 64 of the pipe 66 for the medium to be heated can be electrically coupled to the voltage source via this further connecting device 60. Presently, only the heating wires 62, 64 are schematically illustrated of the pipe 66. Corresponding resistance elements R of the pipe 66 are provided by the heating wires 62, 64, which are schematically illustrated in FIG. 7. Instead of the exemplarily shown resistance elements R, PTC thermistors can also be employed for heating the medium in the pipe 66, which are also referred to as PTC resistors (PTC=Positive Temperature Coefficient). In particular in employment of PTC resistors, however, they can also be electrically connected in parallel with the heating wire 26 of the pipe connector 10.

By connecting the heating wires 62, 64 of the pipe 66 to the further connecting device 60, the pipe 66 can be simply electrically connected in series with the pipe connector 10. Hereto, a corresponding electrical plug connector of the pipe 66 (not shown in detail) can be introduced into the socket 44 or into a further socket, in which the two connecting parts 24, 52 provide the further connecting device 60. Furthermore, the heating wires 62, 64 of the pipe 66 can be connected in firmly bonded manner, for instance by spot welding, to the connecting parts 24, 52 of the further connecting device 60 formed as intrinsically stiff sheets. Due to the exact and well reproducible positioning of the connecting parts 24, 52 of the pipe connector 10, this can be accomplished in automated manner. Thus, according to type of formation of a corresponding plug connector, the pipe connector 10 can thus be directly connected to the voltage source or be electrically connected in series with further electrically heatable components of the pipe system 46. Advantageously, thus, also in a series connection each connecting line thus has a fixedly positioned connection point, which would not be the case if the line 58 would be directly freely contacted with the line 62.

Presently, a further pipe connector 68 disposed in the pipe system 46 is exemplarily shown, which corresponds to the pipe connector 10 schematically shown in FIG. 7 concerning construction. The further pipe connector 68 thus also has the pipe element 20 surrounded by the sleeve 18 (not shown in FIG. 7), around which the heating wire 26 is wound. However, only the first connecting parts 22, 24 of the further pipe connector 68 are electrically connected to a further component of the pipe system 46. Thus, the heating wires 62, 64 of the pipe 66 are electrically conductively connected to these two first connecting parts 22, 24 in particular via a further weld connection. In this electrical connection of the further pipe connector 68, the two further connecting parts 50, 52 remain unused. However, these connecting parts 50, 52 also allow further connection of further electrically heatable components of the pipe system 46 (in analogous manner to the connection of the first pipe connector 10), which all can be supplied with electrical voltage via the plug connector 48.

Thus, the (in FIG. 7 right) pipe connector 10 is presently formed spatially closer to the plug connector 48 and thus as a pipe connector 10 close to supply. In contrast, the electrically heatable pipe 66 leads to the further pipe connector 68 such that the further pipe connector 68 can be referred to as a pipe connector 68 far from supply with respect to the voltage supply.

Thus, by providing the electrical connecting parts 22, 24, 50, 52 of the electrically heatable pipe connectors 10, 68, wiring of the components of the pipe system 46 to be performed for example by means of a robot can be particularly simply achieved. Hereto, correspondingly configured plug connectors 48 only have to be introduced into the socket 44 or such sockets of the respective pipe connector 10, 68 or connecting wires and/or heating wires 62, 64 have to be connected to the electrical connecting parts 22, 24, 50, 52 in firmly bonded manner. This makes the provision of the electrically heatable pipe system 46 particularly low-effort and thus inexpensive.

1. A pipe connector with a first media connection for connecting a pipe for a medium to be heated, with a heating element, which is disposed on a pipe element capable of being passed by the medium, and with at least one further media connection, wherein
the pipe element and the heating element disposed on the pipe element are surrounded by a sleeve element, wherein the sleeve element is disposed in a housing of the pipe connector, by which the media connections are formed.

2. The pipe connector according to claim 1, wherein
the housing is formed as an injection molding part, which is formed by in particular completely overmolding the sleeve element surrounding the pipe element with a plastic.

3. The pipe connector according to claim 1, wherein
the heating element in particular formed as a heating wire circulating around the pipe element in coil-shaped manner is disposed on an outer side of the pipe element.

4. The pipe connector according to claim 1, wherein
an air gap is formed at least in certain areas between the heating element and the sleeve element.

5. The pipe connector according to claim 1, wherein
the sleeve element slid onto the pipe element provided with the heating element and/or locked to the pipe element has at least one stop, on which an axial end of the pipe element abuts.

6. The pipe connector according to claim 1, wherein
the sleeve element has at least one radially protruding structural element in particular formed as a rib.

7. The pipe connector according to claim 1, wherein
at least one pipe section for the medium is formed by the housing of the pipe connector, which fluidically connects an end of the pipe element to one of the media connections formed by the housing.

8. The pipe connector according to claim 1, wherein
the heating element is connected to at least two electrical connecting parts in particular formed as intrinsically stiff sheets.

9. The pipe connector according to claim 8, wherein
the pipe connector has two first electrical connecting parts, which are connected to the heating element, and two further electrical connecting parts, which are galvanically separated from the first electrical connecting parts and connected to each other.

10. The pipe connector according to claim 9, wherein
by one of the first electrical connecting parts and one of the further electrical connecting parts, a first connecting device for connecting the pipe connector to a voltage source is provided, wherein by the other one of the first electrical connecting parts and the other one of the further electrical connecting parts a further connecting device for connecting an electrically heatable component is provided.

11. The pipe connector according to claim 10, wherein
at least one heating wire of the pipe in particular electrically conductively connected to a heating element of a further pipe connector for the medium to be heated is firmly bonded or mechanically connected to the further connecting device.

12. The pipe connector according to claim 8, wherein
end areas of the electrical connecting parts are disposed within at least one socket, which is formed by the housing of the pipe connector.

13. The pipe connector according to claim 8, wherein
the electrical connecting parts are fixed to the pipe element by overmolding with a plastic material in particular forming the pipe element.

14. The pipe connector according to claim 1, wherein
at least one of the media connections is formed for connecting the pipe connector to a pumping device serving for conveying the medium to be heated.

15. A method for manufacturing a pipe connector comprising:
providing a pipe element capable of being passed by a medium;
disposing a heating element on the pipe element;
surrounding the pipe element and the heating element disposed on the pipe element with a sleeve element; and
disposing the sleeve element in a housing of the pipe connector, wherein a first media connection for connecting a pipe for the medium to be heated and at least one further media connection are formed by the housing.
